(19) United States
(12) Patent Application Publication
(10) Pub. No.: US 2023/0373274 A1
(43) Pub. Date: Nov. 23, 2023

(54) Apparatus for Heating an Operator Cab of a Vehicle, and Related Methods

(71) Applicant: AGCO International GmbH, Neuhausen (CH)

(72) Inventor: Mika Juhani Sivula, Suolahti (FI)

(21) Appl. No.: 18/298,499

(22) Filed: Apr. 11, 2023

(30) Foreign Application Priority Data
May 18, 2022 (GB) 2207230.0

(51) Int. Cl. B60H 3/02; B60H 1/00; B60H 1/32

(52) U.S. Cl. CPC B60H 3/024; B60H 1/00849; B60H 1/3233

(57) ABSTRACT

An apparatus for heating an operator cab of a vehicle or machine comprises a cab air heating unit and a cab air duct for conducting air toward an interior region of the cab from the cab air heating unit. An external air intake for conducting external air to an inlet side of the cab air heating unit includes a condensing conduit extending through at least part of the cab air duct. In use, when the condensing conduit is subject to a flow of external air at a temperature below that of the air passing through the cab air duct, an outer surface of the condensing conduit acts as a condensing surface on which moisture in air passing through the cab air duct condenses. This removes moisture from the air before it is introduced into the cab.

### CROSS-REFERENCE TO RELATED APPLICATION

This application claims the benefit of the filing date of U. K. Patent Application 2207230.0, filed May 18, 2022, the entire disclosure of which is incorporated herein by reference.

### FIELD

The present disclosure relates to apparatus and methods for removing moisture from an operator's cab of a vehicle or machine. The apparatus includes arrangements for the removal of moisture from warm air before it is distributed into the operator's cab, the warm air may be air recirculated from within the cab and/or external air heated by a heating unit. The apparatus and methods have been primarily devised for use on vehicle cabs such as those used on tractors and construction machines, but the disclosure is also applicable to cabs for use on other machinery such as combines, forage harvesters, sprayers, and cranes.

### BACKGROUND

Typically, problems arise when the moisture in warm air entering a cab condenses on cab windows and other cold surfaces affecting visibility. Various attempts have been made to try to ease this problem by heating the windows, either by blowing hot air onto the window glass or by heating the windows directly. Direct heating of windows has proved expensive to implement and compromises visibility. The use of hot air also heats the cab, resulting in the cab becoming uncomfortable for the operator. Attempts have also be made to use air conditioning systems for cabs to remove the moisture, but this has also proved expensive to implement and is temperature dependent.

### BRIEF SUMMARY

Aspects of the disclosure provide apparatus for removing moisture from air prior to it being introduced into an operator's cab of a vehicle or machine and methods of operating such apparatus.

In one aspect, the disclosure provides apparatus for heating an operator's cab of a vehicle or machine, the apparatus comprising a cab air duct for conducting air toward an interior region of the cab from a cab air heating unit, and an external air intake for conducting external air to an inlet side of the cab air heating unit, the external air inlet including a condensing conduit extending through at least part of the cab air duct.

In use, external air passing through the condensing conduit cools the conduit to a temperature below that of the, usually warm, air flowing through the cab air duct, so that moisture in the warm air condenses on the exterior surface of the conduit before entering the cab. Such an arrangement provides a particularly simple but efficient way to remove moisture from the warm air before it enters the cab. The warm air may be air heated by the cab air heating unit which is passed through the cab air duct and/or it may be air from within the cab recirculated through the cab air duct and back into the cab.

The apparatus may comprise a blower arrangement for drawing external air in through the external air intake and moving air through the cab air heating unit and the cab air duct toward the interior region of the cab.

The external air intake may be a moisture removal external air intake. The apparatus may have a further external air intake which does not pass through the cab air duct and an air flow valve operable to enable external air to be selectively drawn through the cab air heating unit from the moisture removal external air intake and/or from the further external air intake.

By operation of the air flow valve, the apparatus can be operated in a moisture removal mode, in which external air is directed into the heating unit through the condensing conduit or in a non-moisture removal mode, in which external air is directed into the heating unit through the further external air intake. The non-moisture removal mode might be adopted when the external temperature is very low so that the cold air does not limit the heating capacity of the heating apparatus excessively. The air flow valve could also be operated in a mixed mode, in which some external air is drawn in through both the moisture removal external air intake and the further external air intake.

The air flow valve may be manually actuatable or it may be automatically actuatable. The air flow valve may be controlled automatically in response to at least one predetermined operating parameter, such as any one or more of the following: temperature of the condensing conduit, outside temperature (i.e., the temperature external to the cab), temperature in the interior of the cab, and humidity of the interior of the cab.

The apparatus may be configured to remove moisture from air recirculated from the interior region of the operator's cab. The apparatus may have a recirculation duct through which air from within the interior region of the cab can be drawn to be mixed with external air drawn in through the external air intake for passage back to the cab through the cab air duct. The flow of external air and/or recirculated air through the cab air heating unit may be regulated by the air flow valve and/or by a further air flow valve. A recirculation air duct through which air drawn from within the cab can flow to the cab air heating unit may be connected with an input side of the cab air heating unit downstream of the air flow valve and a recirculation valve provided to direct either recirculated air or external air or a mixture of the two through the cab air heating unit.

The apparatus may include at least one air filter for filtering external air drawn through the moisture removal air intake duct and/or the further external air intake duct.

The apparatus may be part of a HVAC system.

The apparatus may have a condensate collection and removal system for collecting and removing condensate which forms on a surface of the condensing conduit in use. The condensate collection and removal system may be configured to collect condensate which forms on a surface of condensing conduit in use and remove the condensate to the outside of the cab air duct. The condensate collection and removal system may comprise a condensate duct extending to the exterior of the cab air duct.

At least part of the condensing conduit may be inclined to the horizontal and the condensate collection and removal system may be configured such that condensate forming on at least part of a surface of the condensing conduit flows downward towards the condensate collection and removal system.

Some aspects of the disclosure include a method of operating apparatus according to previously mentioned aspect of the invention. The method includes operating the apparatus in a moisture removal mode in which external air is drawn into the cab air heating unit through the moisture removal external air intake while air heated by the cab air heating unit is passed through the cab air duct, such that the temperature of the condensing conduit is lowered below that of the heated air to cause moisture in the heated air to condense onto the condensing conduit.

If the apparatus has a further external air intake and an air flow valve, the method may comprise selectively operating the apparatus in a non-moisture removal mode in which external air is drawn into the a cab air heating unit though the further external air intake while air heated by the cab air heating unit is passed through the cab air duct.

### BRIEF DESCRIPTION OF THE DRAWINGS

Embodiments of the disclosure will now be described, by way of example only, with reference to the accompanying drawings, in which:

FIG. 1 shows an agricultural tractor having a cab and which is fitted with an apparatus for removing moisture from air prior to it being introduced into a cab;

FIG. 2 shows a diagrammatic view of details of an embodiment of apparatus for removing moisture from air prior to it being introduced into a cab, wherein the apparatus is part of a cab heating apparatus and is shown operating in a non-moisture removal mode;

FIG. 3 shows the apparatus of FIG. 2 in a moisture removing mode; and

FIG. 4 shows a diagrammatic view of details of a modified embodiment of the apparatus of FIGS. 2 and 3 including a recirculation duct for recirculating air from the cab.

### DETAILED DESCRIPTION

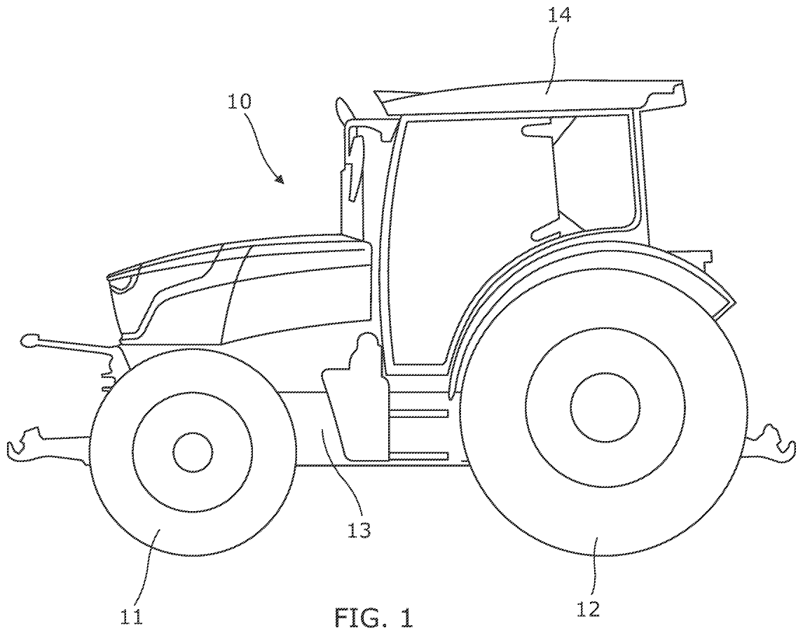

FIG. 1 shows an agricultural tractor 10 having wheels 11 and 12, a chassis 13 and a cab 14. The tractor 10 is fitted with apparatus 15 for removing moisture from air before it is distributed into the cab 14.

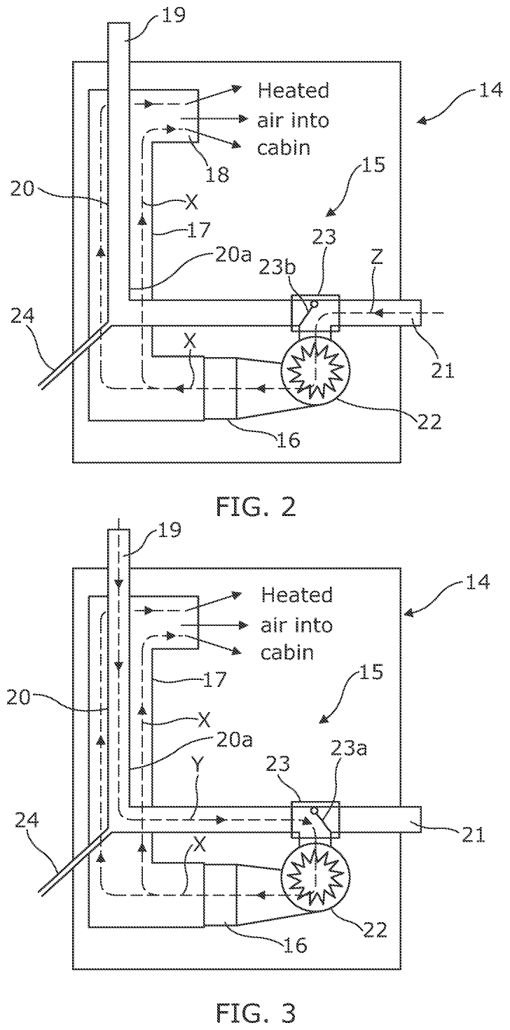

An embodiment of the apparatus 15 for removing moisture from air before it is distributed into the cab 14 and which is part of a heating apparatus for the cab 14 is shown diagrammatically in FIGS. 2 and 3. The apparatus 15 includes a cab air heating unit 16 and a cab air duct 17 along which air (indicated by arrows X) heated by the cab air heating unit 16 is delivered into the cab 14 via an outlet 18. The apparatus 15 includes two external air intakes 19, 21, through which external air (i.e., air external to the cab) can be drawn to pass through the cab air heating unit 16 and the cab air duct 17. A first external air intake 19 will be referred to as a moisture removal external air intake and includes a condensing conduit 20, part of which passes through the cab air duct 17. A second external air intake 21 will be referred to as a further external air intake and does not pass through the cab air duct.

The moisture removal external air intake 19 and the further external air intake 21 are fluidly connected with an inlet side of a fan (blower) 22 forming part of the cab air heating unit 16 by a three-way air flow valve 23. The air flow valve 23 is operative in use to selectively connect the further external air intake 21 to the inlet side of the fan (as shown in FIG. 2) or the moisture removal external air intake 19 to the inlet side of the fan (as shown in FIG. 3).

The apparatus 15 can be operated in a moisture removal mode as illustrated in FIG. 3. In this mode, the air flow valve 23 is moved to position 23a and external air is drawn into the cab air heating unit 16 through the moisture removal external air intake 19 as indicated by the arrows Y. In this mode of operation, the external air Y passing through the moisture removal external air intake 19 will tend to reduce the temperature of the external surface 20a of the condensing conduit 20 below that of the heated air X surrounding it in the cab air duct 17 (e.g., typically below the dew point of the heated air X). The external surface of the conduit will therefore act as a condensation surface on which moisture in the heated air on its way to the cab 14 condenses before reaching the cab 14.

The apparatus 15 may also include a condensate collection and removal system for collecting condensate which forms on the outer surface of the conduit 20 and removing the condensate from the cab air duct 17. In the present embodiment, part of the cab air duct 17 is aligned generally vertically and a portion of the conduit 20 within the cab air duct is also aligned vertically. The condensate collection and removal system includes a condensate duct 24 at a lower end of the vertical portion of the conduit through which condensate can flow under the influence of gravity out of the cab air duct 17. As illustrated, the condensate duct 24 may be inclined downward and may extend externally from the cab 14 so that condensate can be dispensed to a suitable drainage point and into the external environment. Alternatively, the condensate duct 24 could direct condensate to a condensate reservoir (e.g., a tank or bottle) which can be periodically emptied. The condensate collection and removal system could include a trough which encircles the lower end of the conduit 20 arranged so that condensate can flow down the exterior surface 20a of the conduit into the trough which feeds into the condensate duct 24. It will be appreciated that the cab air duct 17 and the conduit 20 need not be aligned vertically but could be inclined at an alternative angle to the horizontal, provided condensate forming on the exterior surface 20a of the conduit 20 tends to flow downward towards the condensate collection and removal system.

The apparatus can alternatively be operated in a non-moisture removal mode as illustrated in FIG. 2. In this mode of operation, the air flow valve 23 is placed in position 23b, and external air is drawn into the cab air heating unit 16 through the further external air intake 21 as indicated by the arrows Z. In the non-moisture removal mode the apparatus 15 acts in a largely conventional manner to introduce heated external air into the cab 14. The apparatus 15 may be operated in the non-moisture removal mode when moisture removal in not required and/or when the external temperature is very low so as not to unduly compromise the capacity of the apparatus 15 to heat the cab 14.

The apparatus 15 can also be operated in a mixed-mode in which the air flow valve 23 is configured to allow external air to be drawn though both of the external air intakes 19, 21 at the same time.

The air flow valve 19 may be controlled manually by the operator to switch between the moisture removal and non-moisture removal modes as required. Alternatively, the air flow valve may be controlled automatically in response to at least one predetermined operating parameter. This might include any one or more of the following: the temperature of the condensing conduit (this could be the temperature of the exterior surface of the conduit in this embodiment), outside temperature (i.e., the temperature external to the cab), temperature in the interior of the cab, and humidity of the interior of the cab.

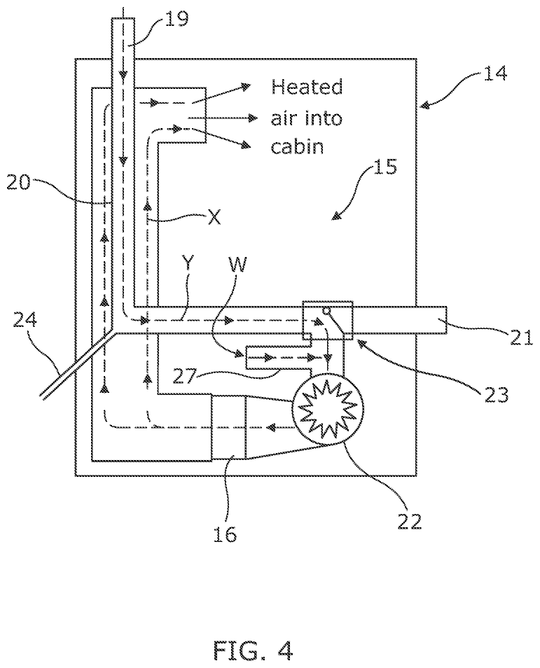

As illustrated in FIG. 4, the apparatus 15 may also have a recirculation air intake 27 through which air from within the cab 14 can be recirculated back through the cab air heating unit 16 and cab air duct 17. In the embodiment illustrated, the recirculation air intake 27 comprises a recirculation air duct through which air drawn from within the cab 14 (as indicated by the arrows W) flows to the cab air heating unit 16 is fluidly connected with an input side of the fan 22 downstream of the air flow valve 23. A recirculation air valve arrangement can be provided to direct either recirculated air or external air or a mixture of the two through the cab air heater unit 16. The recirculation air valve may be operable to regulate the proportions of external and recirculated air in the mixture.

This recirculating air arrangement is beneficial since moisture from within the cab 14 (e.g., from wet boots, clothing, etc.) can be removed. Usually at least some external air Y will be drawn through the moisture removal external air intake 19 to mix with the recirculated air W and the mixed air heated as it passes through the cab air heating unit 16. However, when the air temperature within the cab 14 is sufficiently high and the external air is sufficiently cold to create a condensation point on the condensing conduit 20 within the cab air duct 17, moisture can be removed from recirculated air W without using the cab air heating unit 16 to heat the recirculated air W.

The apparatus 15 may be part of a HVAC system.

The apparatus 15 may include at least one air filter for filtering external air drawn through the moisture removal air intake duct and/or the further external air intake duct.

The present invention provides an arrangement for removing moisture from warm air, which may be air heated by an air heating apparatus or already warm air recirculated from the within the cab, before it is distributed into an operator's cab which does not require expensive parts and can thus be implemented on lower specification vehicles and machines without significantly impacting costs.

Various modifications to the embodiments shown can be made. For example, an alternative fan arrangement may be adopted to generate the air flow through the external air intakes 19, 21, the cab air heating unit 16 and the cab air duct 17. In embodiments, the fan 22 could be provided downstream of the cab air heating unit 16 and/or separate fans could be provided for the moisture removal external air intake 19 and the further external air intake 21. References to air being “drawn” through any part of the apparatus should not be interpreted as limiting the apparatus to configurations in which air is pulled through that part of the apparatus. It will be appreciated that alternative arrangements in which a fan or blower pushes air through such parts of the system could be adopted.

What is claimed is:

1. An apparatus for heating an operator cab of a vehicle, the apparatus comprising:
a cab air heating unit;
a cab air duct configured to conduct air toward an interior region of the cab from the cab air heating unit; and
an external air intake configured to conduct external air to an inlet side of the cab air heating unit, the external air intake including a condensing conduit extending through at least part of the cab air duct.

2. The apparatus of claim 1, wherein the apparatus is configured such that, in use when an inner surface of the condensing conduit is subject to a flow of external air at a temperature below a dew point of the air passing through the cab air duct, an outer surface of the condensing conduit acts as a condensing surface on which moisture in air passing through the cab air duct condenses.

3. The apparatus of claim 1, further comprising a blower arrangement for drawing external air in through the external air intake and moving air through the cab air heating unit and the cab air duct toward the interior region of the cab.

4. The apparatus of claim 1, wherein the apparatus has a further external air intake which does not pass through the cab air duct and an air flow valve operable to enable external air to be selectively drawn into the cab air heating unit through the external air intake or through the further external air intake.

5. The apparatus of claim 4, wherein the air flow valve is manually actuatable.

6. The apparatus of claim 4, wherein the air flow valve is automatically actuatable.

7. The apparatus of claim 6, wherein the air flow valve is configured to be controlled automatically in response to at least one predetermined operating parameter.

8. The apparatus of claim 7, wherein the at least one predetermined operating parameter is selected from the group consisting of a temperature of the condensing conduit, an outside temperature, a temperature in the interior region of the cab, and a humidity of the interior region of the cab.

9. The apparatus of claim 1, wherein the apparatus is configured to remove moisture from air recirculated from the interior region of the cab, the apparatus having a recirculation duct through which air from within the interior region of the cab can be drawn to be mixed with external air drawn in through the external air intake for passage back to the cab through the cab air duct.

10. The apparatus of claim 1, wherein the apparatus further comprises a condensate collection and removal system for collecting and removing condensate which forms on a surface of the condensing conduit in use.

11. The apparatus of claim 10, wherein the condensate collection and removal system is configured to collect condensate which forms on a surface of condensing conduit in use and remove the condensate to the outside of the cab air duct.

12. The apparatus of claim 11, wherein the condensate collection and removal system comprises a condensate duct extending to the exterior of the cab air duct.

13. The apparatus of claim 11, wherein at least part of the condensing conduit is inclined to the horizontal and the condensate collection and removal system is configured such that condensate forming on an outer surface of the condensing conduit flows downward towards the condensate collection and removal system.

14. A method of operating the apparatus of claim 1, the method comprising:
operating the apparatus in a moisture removal mode in which external air is drawn into the cab air heating unit though the external air intake while air heated by the cab air heating unit is passed through the cab air duct, such that the temperature of the condensing conduit is lowered below that of the heated air so as to cause moisture in the heated air to condense onto the condensing conduit.

15. The method of claim 14, wherein the temperature of the condensing conduit is lowered below a dew point of the external air.

16. A method of operating the apparatus of claim 4, the method comprising:
selectively operating the apparatus in one of:
a moisture removal mode in which external air is drawn into the cab air heating unit though the external air intake while air heated by the cab air heating unit is passed through the cab air duct, such that the temperature of the condensing conduit is lowered below that of the heated air so as to cause moisture in the heated air to condense onto the condensing conduit; or
a non-moisture removal mode in which external air is drawn into the cab air heating unit though the further external air intake whilst air heated by the cab air heating unit is passed through the cab air duct.
